(19) United States
(12) Patent Application Publication
(10) Pub. No.: US 2012/0305375 A1
(43) Pub. Date: Dec. 6, 2012

(54) Cord Switch for Controlling a LED Lamp

(76) Inventors: Ka Kin Kwok, Kowloon Bay (HK); Xiao Po Rao, Jiangmen (CN)

(21) Appl. No.: 13/358,583

(22) Filed: Jan. 26, 2012

(30) Foreign Application Priority Data
Jun. 3, 2011 (CN) 201110149032.4

(51) Int. Cl. H01H 13/04

(52) U.S. Cl. 200/293

(57) ABSTRACT

The invention provides a cord switch for controlling a LED lamp, comprising a casing, a push button switch that consists of a push button and a conductive slice arranged in the casing, and connection terminals and housings for the connection terminals. Each connection terminal has a plug or a pin at its front end and a rivet portion at its rear end. The housing receives the connection terminals, forming a connector which is then inserted into the casing, with a part of the plug or the pin in close contact with the conductive slice. For this cord switch, the wire connection comprises the steps of riveting wires in the rivet portion at the rear end of the connection terminals, inserting the connection terminals into the housing to form a connector, and inserting the connector into the casing, without need to disassemble and reassemble the casing, or fasten the bolts.

### CROSS REFERENCE TO RELATED APPLICATIONS

This utility patent application claims priority to Chinese patent application no. 201110149032.4 filed on Jun. 3, 2011, which is incorporated by reference herein.

### FIELD OF THE INVENTION

This invention relates to a switch, and more particularly, to a cord switch for controlling a LED (Light Emitting Diode) lamp, which uses pluggable connection terminals to provide the convenient plug-in connection of the wires.

### BACKGROUND OF THE INVENTION

The LED lamps currently available in the market are generally controlled by remote switches; and some of the LED lamps are sold together with switches after the lamps and the switch are assembled together. However, the current control switches of the LED lamps commonly uses bolts for fastening the wires, the wire connection of these switches comprises the steps of disassembling the casing of the switch, connecting the wires to the switch and fastening the wires with bolts, and assembling the disassembled casing. This connection process involves a number of steps and is quite complicated, making it inconvenient for mass production and assembly and for the end users to perform the wire connections.

### SUMMARY OF THE INVENTION

In order to tackle the above mentioned technical problem, an object of the present invention is to provide a switch that uses pluggable connection terminals for plug-in connection, thereby simplifying considerably the wire connection of the switch.

Accordingly, the present invention provides a cord switch for controlling a LED lamp, which comprises:
a casing;
a push button switch that consists of a push button and a conductive slice arranged in the casing;
connection terminals each having a plug or a pin at its front end and a rivet portion at its rear end;
housings for the connection terminals each having two through holes for accommodating the connection terminals;
wherein the connection terminal is riveted to be received in the housing to form a connector; and the connector is inserted into the casing with a part of the plug or the pin in close contact with the conductive slice.

In a preferred embodiment of the invention, the casing is formed by assembling an upper casing portion and a lower casing portion.

In a further preferred embodiment of the invention, a plurality of hook members projecting outward are provided on the underside of the upper casing portion and a plurality of slots matchable with the hook members are located in the lower casing portion; a plurality of inner notches which respectively engage with protrusions of the hook members are formed on an inner wall of the lower casing portion at upward positions which correspond to the slots. The inner notches are configured to provide the ease of guiding the hook members into the slots and to allow the simple and convenient assembly of the upper and lower casing portions through the hook members.

In a preferred embodiment of the invention, a partition for separating wires disposed in the lower casing portion is provided so as to avoid the contact between the two poles, effectively preventing the event of short circuit.

In another preferred embodiment of the invention, an elastic blade is provided on each connection terminal and a groove or projecting collar which matches with the elastic blade is provided on an inner side wall of the housing. When the connection terminal is inserted into the housing, the elastic blade is in contact with the inner side wall of the housing and is secured firmly to the groove or to the projecting collar so that the connection terminal is not easily detached.

In a yet preferred embodiment of the invention, a barb portion for self-locking the housing is provided on an outer side wall of the housing between the two through holes, and a lock block is positioned respectively in the upper and lower casing portions to correspond to the barb portion. The lock block has a slant surface on the side from which the housing is inserted to provide the easy insertion, a vertical surface on the side from which the housing exits, allowing the barb portion to be locked firmly so that the housing is not detached easily.

In a further preferred embodiment of the invention, a guiding slot is provided on the housing at the opposite side to the barb portion, and a projecting block which matches with the guiding slot is positioned respectively in the upper and lower casing portions, where an opening for inserting the housing is located. By aligning the guiding slot with the projecting block, the connection between the housing and the casing is firm yet simple.

The advantages of this invention include the following. With the above-mentioned structures, the cord switch for controlling a LED lamp enables the wire connection by riveting the wires in the rivet portion at the rear end of the connection terminals, followed by inserting the connection terminals into the housing to form a connector which is then inserted into the casing. As such, there is no need to disassemble and reassemble the casing, or fasten the wires with bolts when connecting the wires. As a result, the efficiency of connecting and assembling can be increased effectively, making it possible for mass production and processing. In addition, the cord switch of this invention is characterized by appealing appearance and compact structure.

To have a better understanding of the invention, reference is made to the following detailed description of the invention and embodiments thereof in conjunction with the accompanying drawings.

### BRIEF DESCRIPTION OF THE DRAWINGS

FIG. 1 is a schematic diagram of the structure of a cord switch constructed according to a preferred embodiment of the invention.

FIG. 2 is an exploded view of the cord switch shown in FIG. 1.

FIG. 3 is an enlarged view of Part A shown in FIG. 2.

FIG. 4 is a schematic diagram of the lower casing portion.

FIG. 5 is a schematic diagram of the upper casing portion.

FIG. 6 is a schematic diagram of the push button switch.

FIG. 7 is a cross-sectional view of the housing for the connection terminals.

### DETAILED DESCRIPTION OF THE PREFERRED EMBODIMENTS

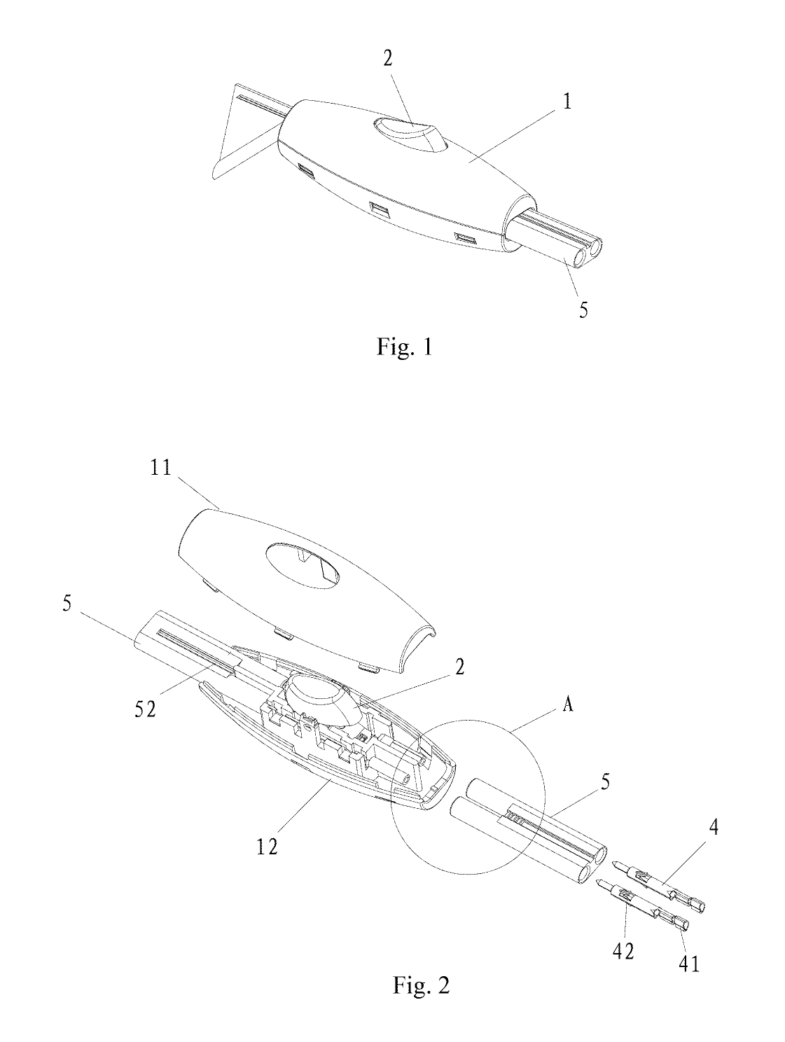

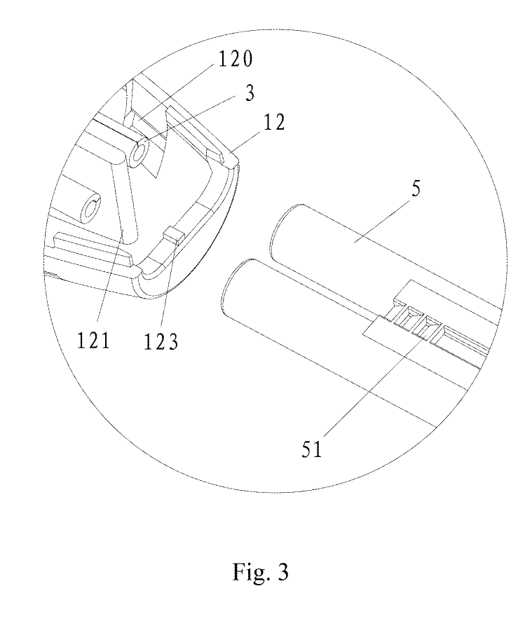

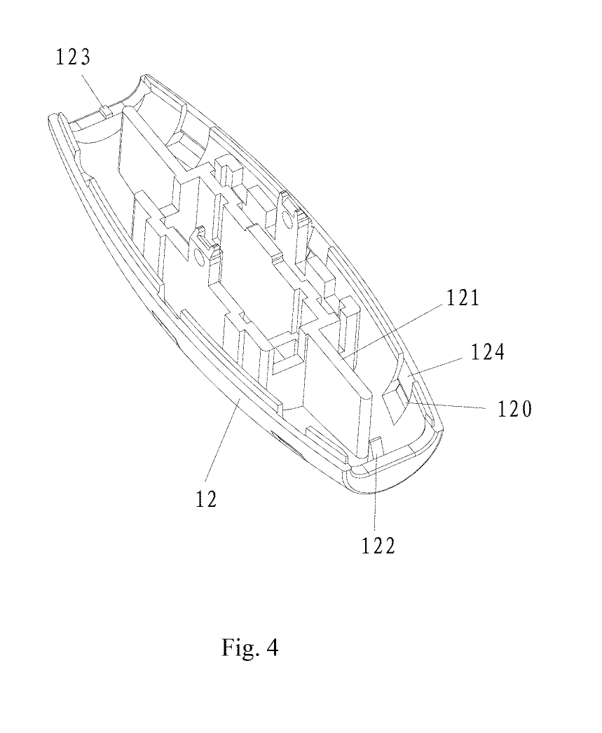

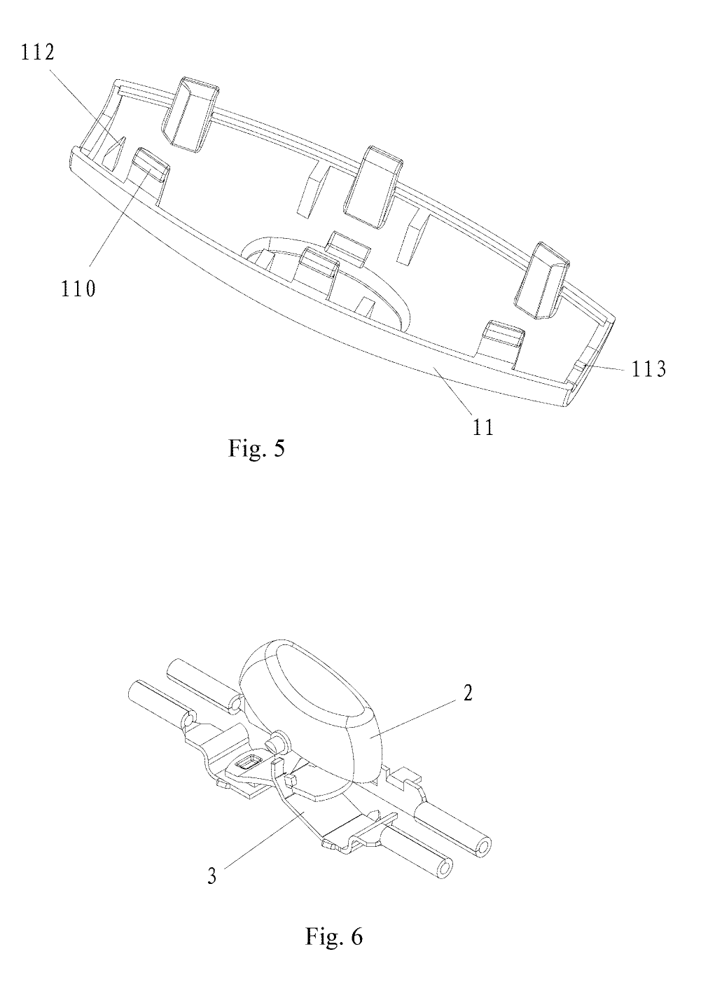

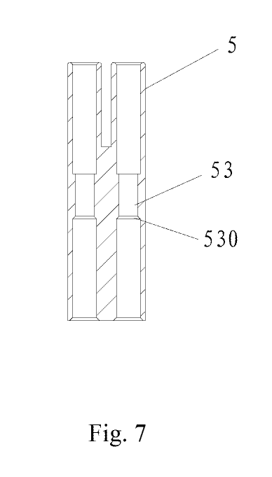

Referring to FIGS. 1 to 7, there illustrate a cord switch for controlling a LED lamp constructed according to the invention, comprising a casing 1 which consists to of an upper casing portion 11 and a lower casing portion 12. The underside of the upper casing portion 11 has a plurality of hook members 110 projecting downward; and both sides of the lower casing portion 12 have a plurality of slots 120 which match with the hook members 110. On the inner wall of the lower casing portion 12 at upward positions which correspond to the slots 120, a plurality of inner notches 124 are provided which respectively engage with protrusions of the hook members 110. The inner notches 124 are configured to provide the ease of guiding the hook members 110 into the slots. The upper and lower casing portions 11 and 12 are assembled to form the casing 1 by interlocking the hook members 110 with the slots 120. In addition, a plurality of hook members projecting upward may be provided in the upper side of the lower casing portion 12, and the slots which match with the hook members are provided in the upper casing portion 11. By interlocking the hook members with the slots, the upper and lower casing portions 11 and 12 can be assembled into the casing 1. The casing 1 includes a push button switch which consists of a push button 2 and a conductive slice 3. This cord switch further comprises connection terminals 4 and housings 5 for the connection terminals. The housing 5 is a double-pole structure formed by connecting the two poles together and having two through holes for accommodating the connection terminals 4. Each connection terminal 4 has a plug or a pin at its front end and a rivet portion 41 at its rear end. The connection terminal 4 is to be received in the housing 5 to form a connector, and the connector is inserted into the casing 1, with a part of the plug or the pin in close contact with the conductive slice 3. The connecting end of the conductive slice 3 is designed to be hollow or solid for easy connection with the connection terminal 4. For the cord switch for controlling a LED lamp having the above mentioned structures, the wire connection comprises the following steps of riveting the conductive parts of the wire firmly in the rivet portion 41 of the connection terminal 4, inserting the connection terminal 4 into the housing 5 to form a connector, and inserting the connector into the casing 1. Such a connection is quick and simple, without the need to disassemble and reassemble the casing, or fasten the bolts for positioning the wires. It is suitable for mass production and processing; the efficiency of making connection and assembling can be increased effectively. In addition, the cord switch of this invention is characterized by appealing appearance and compact structure.

The lower casing portion 12 includes a partition 121 and there is a gap at the front end of the connector which corresponds to the partition 121. The partition 121 separates the two poles from each other when connecting the wires, effectively preventing the event of short circuit by avoiding the contact between the two poles.

The connection terminal 4 has an elastic blade 42, and a projecting collar 53 is included on the inner side wall of the housing 5 which matches with the elastic blade 42. In order for easy insertion, the projecting collar 53 has a slant surface 530 on the side from which the connection terminal 4 is inserted. When the connection terminal 4 is inserted into the housing 5, the elastic blade 42 and the inner side wall of the housing 5 come into contact, and the elastic blade 42 is secured firmly at the rear of the projecting collar 53 so that the connection terminal 4 is not detached easily. In addition, the projecting collar 53 can be replaced by a groove for securing firmly the connection terminal 4 in place.

Moreover, a barb portion 51 for self-locking the housing 5 is provided on an outer side wall of the housing 5 between the two through holes, and a lock block 112, 122 is positioned respectively in the upper and the lower casing portions 11 and 12 to correspond to the barb portion 51. The lock block 112, 122 has a slant surface on the side from which the housing 5 is inserted for the sake of easy insertion, and a vertical surface on the side from which the housing 5 is exiting, allowing the barb portion 51 to be locked firmly, which enables the fastening of the housing 5 to the casing 1 to prevent it from being detached. There is a guiding slot 52 provided on an outer side wall of the housing 5 at the opposite side to the barb portion 51, and a projecting block 113,123 which matches with the guiding slot 52 is positioned respectively in the upper and lower casing portions 11 and 12, where an opening for inserting the housing is located. By aligning the guiding slot 52 with the respective projecting block 113, 123, the connection of the housing 5 is firm yet simple. The arrangement of the barb portion 51 and the guiding slot 52 achieves the steady connection between the connector and the casing 1. Since the movement of the housing 5 is not permitted, the firmness of the connection is further ensured. In addition, the two connectors 5 are inserted respectively into the two ends of the casing 1. One of the connectors 5 is configured to have the barb portion 51 for engagement with the lock block 112 on the upper casing portion 11, and the other is configured to have the bard portion 51 for engagement with the lock block 122 on the lower casing portion 12. This arrangement of the two barb portions 51 on different respective sides of the two casing portions prevents the occurrence of misconnection of the two poles.

While the embodiments described herein are intended as exemplary cord switch, it will be appreciated by those skilled in the art that the present invention is not limited to the embodiments illustrated. Those skilled in the art will envision many other possible variations and modifications by means of the skilled person's common knowledge without departing from the scope of the invention; however, such variations and modifications should fall into the scope of this invention.

The cord switch of this invention allows for convenient wire connection with increased efficiency, making it possible for mass production. Furthermore, since this cord switch is structurally compact and has an appealing appearance, its market prospect is thus promising.

What is claimed is:

1. A cord switch for controlling a LED lamp, which comprises:
a casing (1);
a push button switch which consists of a push button (2) and a conductive slice (3) arranged in the casing (1);
connection terminals (4) each having a plug or a pin at its front end and a rivet portion (41) at its rear end; and
housings (5) for the connection terminals (4) each having two through holes for accommodating the connection terminals (4);
wherein the connection terminal (4) is riveted to be received in the housing (5) to form a connector; the connector is inserted into the casing (1) with a part of the plug or the pin in close contact with the conductive slice (3).

2. The cord switch for controlling a LED lamp as claimed in claim 1, wherein the casing (1) is formed by assembling an upper casing portion (11) and a lower casing portion (12).

3. The cord switch for controlling a LED lamp as claimed in claim 2, wherein a plurality of hook members (110) projecting outward are provided on the underside of the upper casing portion (11); and a plurality of slots (120) matchable with the hook members (110) are located in the lower casing portion (12).

4. The cord switch for controlling a LED lamp as claimed in claim 3, wherein a plurality of inner notches (124) which respectively engage with protrusions of the hook members are formed on an inner wall of the lower casing portion (12) at upward positions which correspond to the slots (120).

5. The cord switch for controlling a LED lamp as claimed in claim 2, wherein a partition (121) for separating wires is provided in the lower casing portion (12).

6. The cord switch for controlling a LED lamp as claimed in claim 1, wherein each of the connection terminals (4) has an elastic blade (42) in contact with an inner side wall of the housing (5).

7. The cord switch for controlling a LED lamp as claimed in claim 6, wherein a projecting collar (53) which matches with the elastic blade (42) is provided in the housing (5).

8. The cord switch for controlling a LED lamp as claimed in claim 6, wherein a groove which matches with the elastic blade (42) is provided in the housing (5).

9. The cord switch for controlling a LED lamp as claimed in claim 1, wherein a barb portion (51) for self-locking the housing (5) is provided on an outer side wall of the housing (5) between the two through holes and a lock block (112, 122) is positioned respectively in the upper and lower casing portions to correspond to the barb portion (51).

10. The cord switch for controlling a LED lamp as claimed in claim 9, wherein a guiding slot (52) is provided on the housing (5) at the opposite side to the barb portion (51), and a projecting block (113, 123) which matches with the guiding slot (52) is positioned respectively in the upper and lower casing portions (11, 12), where an opening for inserting the housing (5) is located.
